(19) United States
(12) Patent Application Publication
(10) Pub. No.: US 2004/0163825 A1
(43) Pub. Date: Aug. 26, 2004

(54) Fire and explosion suppression

(76) Inventors: Robert George Dunster, Buckinghamshire (DE); Simon John Davies, Staines Middlesex (DE); Robert James Lade, Marlow (DE); Julian Grigg, Burnham (DE)

Correspondence Address: MERCHANT & GOULD PC, P.O. BOX 2903, MINNEAPOLIS, MN, 55402-0903, US

(21) Appl. No.: 10/472,773

(22) PCT Filed: Mar. 28, 2002
(86) PCT No.: PCT/GB02/01495

(30) Foreign Application Priority Data
Mar. 29, 2001 (GB) 0107886.4
Jul. 27, 2001 (GB) 0118374.8
Sep. 26, 2001 (GB) 0123144.8

(51) Int. Cl. A62C 35/00

(52) U.S. Cl. 169/44; 169/9; 169/5; 169/13

(57) ABSTRACT

A fire and explosion suppression system comprises a source (5) of high pressure water which is fed to a misting nozzle (13) or other water mist generating means at one input of a mixing unit (6), and a source (14) of high pressure inert gas, such as nitrogen, which is fed along a pipe (20) to another input of the mixing unit (6). Inside the mixing unit (6), water mist, in the form of an atomised mist of very small droplet size is mixed with the pressurised gas and exits the mixing unit (6) at high pressure and high velocity along a pipe (22) and is thence discharged through spreaders (26, 28). Separation of the mist production from the actual discharge of the mist, and the entraining and transporting of the mist between these two stages at high pressure and high velocity, produces an output mist of very small droplet size which is carried by the entraining and transporting high pressure gas into the area to be protected, enabling a total flooding capability.

### BACKGROUND OF THE INVENTION

1. Field of the Invention

The invention relates to fire and explosion suppression. Embodiments of the invention, to be described below by way of example only, use a mist of a liquid extinguishant, such as water, as the suppression agent.

2. Description of the Related Art

It is known to create a mist of a liquid extinguishant, such as water, using a pressurised gas which acts on a jet of the liquid to atomise it into a mist which is then sprayed into the area to be protected—see, for example, U.S. Pat. No. 5 799 735. It is also, of course, known to extinguish fires by using a discharge of an inert gas on its own. It is an aim of the invention to provide improved suppression of fires and explosions.

### BRIEF SUMMARY OF THE INVENTION

According to the invention, there is provided a fire and explosion suppression system, comprising a source of liquid extinguishing agent and a source of pressurised inert gas, mist producing means connected to receive a flow of the liquid extinguishing agent to produce a mist therefrom, mixing means for mixing the already-produced mist into a flow of the pressurised inert gas from the source thereof to produce a discharge in the form of a two-phase mixture comprising a suspension of droplets of the mist in the pressurised inert gas, and transporting means for transporting the two-phase mixture to separate discharge means.

According to the invention, there is further provided a fire and explosion suppression method, comprising the steps of producing a mist from a pressurised liquid extinguishing agent, mixing the already-produced mist into a flow of pressurised inert gas to produce a two-phase mixture comprising a suspension of droplets of the mist in the pressurised inert gas, and transporting the two-phase mixture for separate discharge.

According to the invention, there is also provided apparatus for producing a mist from a liquid, comprising an eductor.

According to the invention, there is yet further provided a method of producing a mist from a liquid, in which a gas is fed under pressure to an eductor to draw the liquid into the eductor to produce the mist.

### BRIEF DESCRIPTION OF THE DRAWINGS

Fire and explosion suppression systems and methods according to the invention, employing a mist of a liquid extinguishing agent, will now be described, by way of example only, with reference to the accompanying diagrammatic drawings in which:

FIG. 1 is a schematic diagram of one of the systems;

FIG. 2 shows a modification to the system of FIG. 1;

FIGS. 3 and 4 are graphs for explaining operation of the systems of FIGS. 1 and 2;

FIG. 5 shows a further modification to the system of FIG. 1;

FIG. 6 is a graph for explaining the-operation of the system of FIG. 5;

FIG. 7 shows a modification to the system of FIG. 5; and

FIG. 8 shows another modification of the system of FIG. 5.

### DETAILED DESCRIPTION OF EMBODIMENTS OF THE INVENTION

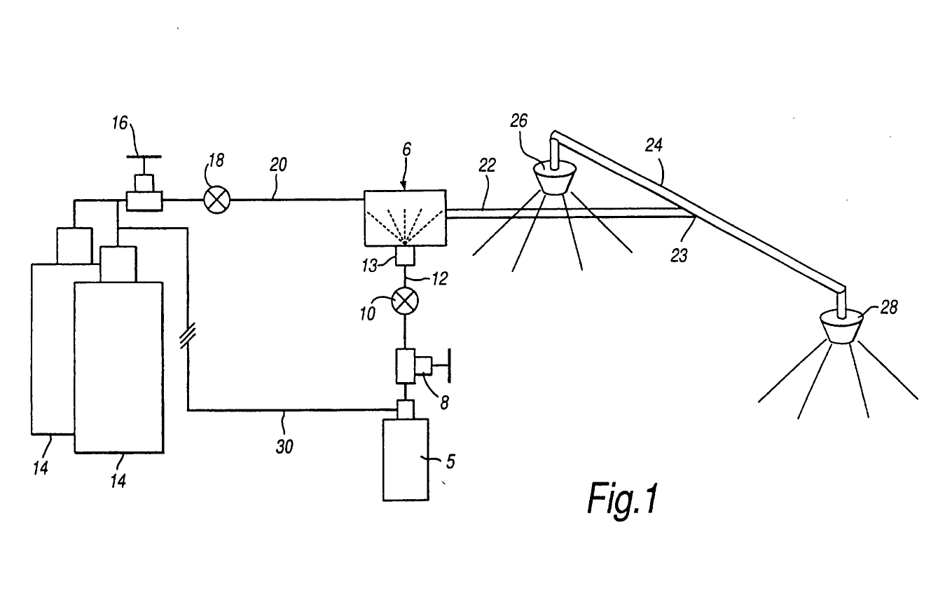

Referring to FIG. 1, the system has a vessel 5 storing water. The vessel 5 is connected to an input of a mixing unit 6 via a pressure regulator 8, a flow regulator 10 and a pipe 12. At the input to the mixing unit 6, the pipe 12 feeds the water to a misting nozzle 13 or other water mist generating means (for example, a simple orifice or restriction hole across which a pressure differential is maintained).

The system also includes a vessel or vessels 14 storing an inert gas such as nitrogen. Vessels 14 have an outlet connected via a pressure regulator 16, a flow regulator 18 and a pipe 20 to another input of the mixing unit 6. The mixing unit 6 has an outlet pipe 22 which connects with a distribution pipe 24 terminating in spreader or distribution heads 26,28.

In use, water from the vessel 5 and gas from the vessels 14 are fed under high pressure to the mixing unit 6 through the pressure regulators 8 and 16 and through the flow regulators 10 and 18 which regulate the pressure and flow rates.

The water in the vessel 5 may be pressurised by a separate pressure source not shown. Instead, though, it could be pressurised by the gas within vessels 14, via an interconnection 30.

The nozzle 13 comprises any suitable form of nozzle for atomising the water to produce a water mist. Examples of suitable misting nozzles include single or multi-orifice plates, single or multi-orifice phase direct impingement nozzles, spiral insert nozzles and rotating disc nozzles. In principle, any standard water mist type nozzle can be used.

In the mixing chamber 6, the water mist produced by the misting nozzle 13 is effectively added to the inert gas. The resultant two-phase mixture (that is, water mist droplets carried by the inert gas) exits the mixing chamber along the outlet pipe 22 and is carried at high velocity to a T-junction 23, and thence along the distribution pipe 24 to exit from the spreaders 26,28 into the volume to be protected (that is, the room, enclosure or other space where a fire or explosion is to be suppressed).

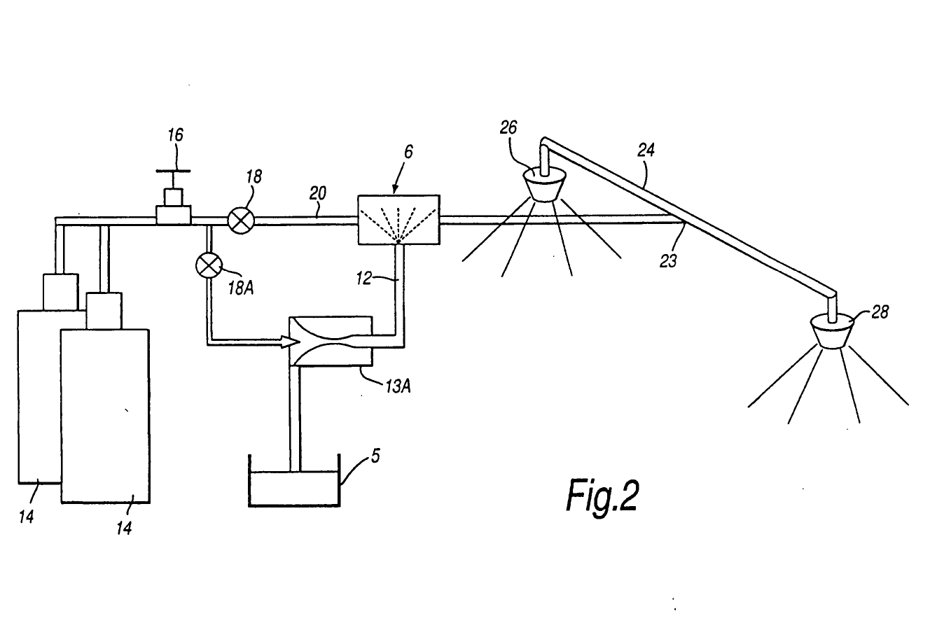

In the system of FIG. 2, the misting nozzle 13 is replaced by an eductor 13A which uses a venturi effect. A subsidiary flow of the high pressure gas from the vessels 14 passes via a flow regulator 1 8A into the eductor 13A where the venturi effect causes a low pressure area to be formed. This low pressure area draws water from the vessel 5 via the flow regulator 10, the water being at low pressure or unpressurised. A water mist is formed at the point of intersection between the two fluids. This mist exits along the pipe 12 into the mixing chamber 6 where it is added to the main flow of inert gas arriving via flow regulator 18 and pipe 20 in the system in the manner described with reference to FIG. 1. The resultant two-phase mixture (water mist droplets carried by the inert gas) exits along pipe 22 as described with reference to FIG. 1.

In each case (FIGS. 1 and 2), where the water mist and the very high flow of inert gas join, a process known as air blast or aerodynamic atomisation takes place. The water droplets interact with the fast flow of inert gas, and rapidly form into flattened sheets which break up into a cloud of minute droplets. The droplet size in the cloud depends on the relative flow rates between the water and the inert gas. The preferable median droplet size is between 5 and 60 micrometres.

It will be seen that, in the systems of FIGS. 1 and 2, the mixing chamber 6, in which the water mist is produced, is separate from and distanced from the outlets or spreaders 26,28. The spreaders 26,28 are not used for the formation of mist but simply for discharging the already formed mist. The systems thus contrast with systems using nozzles which combine a mixing chamber in which the mist is produced with outlets for discharging that mist into the area or enclosure to be protected. Advantageously, the mixing chamber 6 is at least one metre downstream of any flow regulators (e.g. 10,18) and upstream of the first T-junction (e.g. 23) or elbow.

The mist exiting the mixing unit 6 moves at high velocity and is entrained by and within the high pressure inert gas. The resultant turbulence in the pipe 22 helps to reduce the size of the droplets in the water mist. The high velocity water mist exits the spreaders as a two-phase mixture, consisting of the water droplets within the inert gas. The gas continues to expand, on exiting the spreaders 26,28, producing an even mixture. Fine water droplets are suspended within the gas throughout the discharge.

The conditions which produce turbulent flow in the pipe 22 will vary with pipe dimensions, nature of the gas, gas velocities and pressures and gas properties. These conditions can best be described in terms of the Reynold's number, Re. In general for turbulent flow, Re>^{˜}2300. It is considered that in practice Re should be greater than 4000 and advantageously greater than 12000 at all points in the pipe network. From calculations carried out on the velocity and Reynold's number for enhanced mist production, it is believed that the maximum turbulence level and pressures will occur at or very close to the mixing chamber (or eductor). Beyond this point, pressure losses occur within the pipe 22 and hence turbulence levels will drop. Therefore, the greatest potential for producing fine water droplets will occur within or close to the mixing chamber. However, owing to the turbulent nature within the pipe, it is likely that water droplets will continue to impact against each other within the gas flow and continue to strip (reduce in droplet size). As the flow and turbulence levels within the pipe begin to fall, some larger water droplets begin to drop out of suspension. The difference in Reynold's number (turbulence) between the mixing chamber and the outlet spreaders will determine how much water falls out of suspension. Only the fine droplets that remain suspended in the flow will exit the system and disperse. The water that falls out of suspension will either remain within the pipe network or exit through the outlet spreader as very coarse water droplets. These larger droplets will not aid fire suppression.

The spreaders 26,28 do not have any significant effect on the two-phase mixture. The function of the spreaders is

(a) to ensure homogeneity of distribution of the combined mist and inert gas within the protected volume;

(b) to ensure that the correct amount of suppressant (the combined mist and inert gas) enters each part of the protected volume, by varying the distribution of the spreaders;

(c) to ensure the correct discharge time, typically about 60 seconds.

As the suppressant leaves the spreaders, the cloud of water mist and inert gas continues to expand and forms an even distribution within the protected volume. The water mist remains suspended within the inert gas during the discharge. Because the liquid droplets are so small, they remain suspended for a significant period of time following the discharge. Therefore, a total flooding effect can be achieved for as long as the water droplets remain suspended—which can be for several minutes.

The systems described have considerable advantages over fire extinguishing systems based on the use of inert gases alone. Fire extinguishing systems based on the use of inert gases on their own are well known but are not greatly favoured, in spite of having substantially zero ozone depletion potential (ODP) and zero global warming potential (GWP). In order to act efficiently for fire extinguishing purposes, inert gases must be used in relatively high concentration, in the range of 27-38 vol %. Large quantities of the inert gases therefore have to be stored. Because the inert gas has to be stored under relatively high pressure, storage cylinders are heavy. Such a system can therefore require increased floor space and increased floor loading capabilities.

A further disadvantage of fire extinguishing systems relying solely on inert gas is that the relatively high concentration of the inert gas which is required, to achieve efficient extinguishing action, necessarily reduces the oxygen concentration in the protected volume significantly. Thus, oxygen concentrations in the protected enclosure may be reduced to between 11 to 14 vol %. This obviously has implications for human survivability in the protected enclosure. Reduced oxygen concentration within this range may be survivable in the short term but is at least potentially unsatisfactory.

This problem is overcome in the systems described with reference to FIGS. 1 and 2 because the water mist added to the inert gas provides significantly increased fire suppression performance and this in turn significantly reduces the amount of inert gas needed. Not only is there a consequent reduction in the space and weight requirements, but, because the inert gas concentration is lower, oxygen concentration within the protected enclosure is higher and there is less oxygen depletion risk to persons present in the enclosure. Clearly, water has no adverse ODP or GWP effects and therefore has no adverse environmental effect.

The addition of the water mist to the inert gas essentially enhances the fire suppression capability by raising the overall heat capacity of the atmosphere in the protected volume to such a level that combustion can no longer be sustained. In flame-type combustion, the reactions taking place necessarily involve high energy species such as free radicals, requiring the existence of high temperature—for example, 1,500-1,700 K, below which the reactions will not proceed and the combustion is thus not sustained. In other words, a large proportion of the energy released by the combustion process has to be used to heat up the air to flame temperature. If the heat capacity of the atmosphere within the protected enclosure is increased sufficiently (for example, up to 190-210 J/K/mol of oxygen), combustion cannot be sustained. The added water mist behaves in exactly the same way as the inert gas: it contributes heat capacity but does not otherwise become involved with the chemistry of the flame.

Because of the very small size of the water droplets, they require a much shorter residence time in the flame than systems employing larger water droplets, before fully evaporating. When water droplets evaporate, the combined heat capacities of water in its liquid, latent and vapour phases all combine to produce a more effective suppressant.

In a modification, a suitable chemical agent is added to the water to improve the extinguishing and suppressing action. A suitable chemical agent is potassium hydrogen carbonate (KHCO₃). The presence of this chemical agent in the final mist increases the efficiency of fire suppression very significantly.

It is also important to note that the systems described preserve the total flooding capability of purely gaseous fire extinguishing systems. Because the water mist is added to the high pressure inert gas and then transported under high pressure and at high velocity along the pipe 22 (see FIGS. 1 and 2), the water is maintained in mist form with no significant loss of the mist through coalescence, and in fact the droplet size may be reduced further during transport down the pipe. Upon discharge into the area to be protected, the mist within the inert gas has very effective total flooding capability.

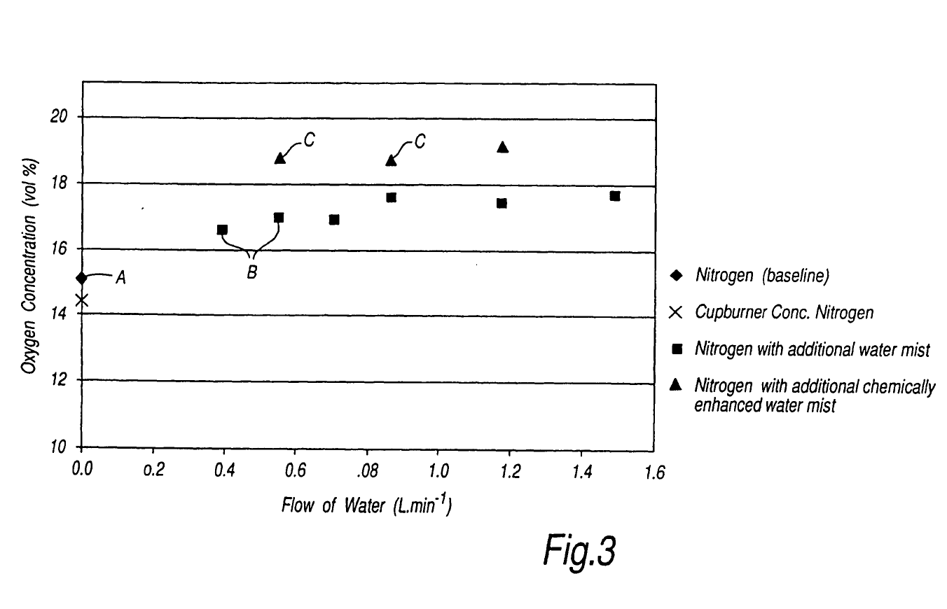

The reduced oxygen depletion produced by adding water mist to the inert gas in the manner described is illustrated more clearly in FIG. 3 which shows results of tests carried out to establish the amount of oxygen depletion required to extinguish a class B fire under specific test conditions. The fire was a n-heptane fire within a one cubic metre test chamber and was required to be extinguished within one minute. The lefthand vertical axis plots oxygen concentration (vol %) and the horizontal axis plots the amount of water mist present (flow rate of water in litres per minute). The inert gas used is nitrogen.

When there is no water mist present, the diamond-shaped plot A shows that the oxygen concentration needs to be reduced to about 15 vol % to achieve complete fire extinction. Taking into account the normal safety factor which would be required to be employed in a fire extinguishing system based solely on inert gas, the system would be required to have capability of reducing the oxygen concentration to 13.3 vol %. It is thus clear that this is quite close to the lower limit at which human survivability begins to be compromised (and at which particularly vulnerable people could be at significant risk). The square plots B show how the addition of water mist at various concentrations enable the fire to be extinguished at significantly higher levels of oxygen concentration. For example, when the water mist is present at a flow rate of about 1.5 litres per minute, the fire is completely extinguished at an oxygen concentration of just under 18%. Again, taking safety factors into account, such a system would need to be designed to reduce oxygen concentration to lie within the range between 15.3 and 16.5 vol %—where the risk to human survivability is very much less.

The triangular-shaped plots C in FIG. 3 show oxygen concentrations which are required in order to provide complete fire extinction when a chemical agent (such as KHCO₃) is added to the water mist. It is clear that the required oxygen depletion is even lower.

In order to test the operation of a system similar to that shown in FIG. 1 (but having a single spreader outlet), experiments were carried out in a 1m³ test chamber. Eight 50 mm diameter and 50 mm deep panfires were filled with water and n-heptane, and placed on shelves or stands which were evenly distributed within the test chamber. Each fire was partially baffled, which helped to reduce the effects of flame stretching caused by the flow of suppressant into the chamber. The spreader was screwed inside the chamber, at the centre of its top.

All eight fires were ignited and allowed to burn for 30 seconds. The test chamber was then closed. After a total of 50 seconds, nitrogen alone was discharged into the chamber by the system for a predetermined time.

The flow of nitrogen was adjusted until the fires had been extinguished. When the minimum extinguishing concentration for nitrogen had been achieved for the chamber, the experiments were repeated adding known flows of water to the flow of nitrogen. The resultant enhanced water mist provided better extinguishing properties and a new minimum extinguishing concentration was established. Further fire tests were carried out using water and potassium bicarbonate solution as the added suppressant to the flow of nitrogen. As before, minimum extinguishing concentrations were established. After the fire testing had been completed, analysis was carried out on the water droplet sizes produced by the enhanced water mist generation system.

The results of the experiments can be summarised as follows:

The minimum extinguishing concentration for nitrogen (baseline tests) using the above apparatus and a flow rate of 800 L/min, was 29%.

The minimum extinguishing concentration for nitrogen and enhanced water mist was 16 vol %. This was achieved when 0.87 L/min of water was added to 800 L/min of nitrogen. The results show that enhanced water mist requires 45% less nitrogen to suppress the same fires when compared to the nitrogen baseline results.

The minimum extinguishing concentration for nitrogen and chemically enhanced water mist was 8.5%. This was achieved when 1.2 L/min of potassium bicarbonate solution was added to 800 L/min of nitrogen. These results show that enhanced chemical water mist requires 70% less nitrogen to suppress the same fires when compared to the nitrogen baseline results.

The average water droplet sizes that produced the most effective results in the fire test programme were D_{v=0.1}=6.3 μm, D_{v=0.5}=26.3 μm, and D_{v=0.9}=78.5 μm (where D_{v=0.5} is the mean droplet size, 10% of the droplets have a diameter below D_{v=0.1}, and 90% of the droplets have a diameter below D_{v=0.9}).

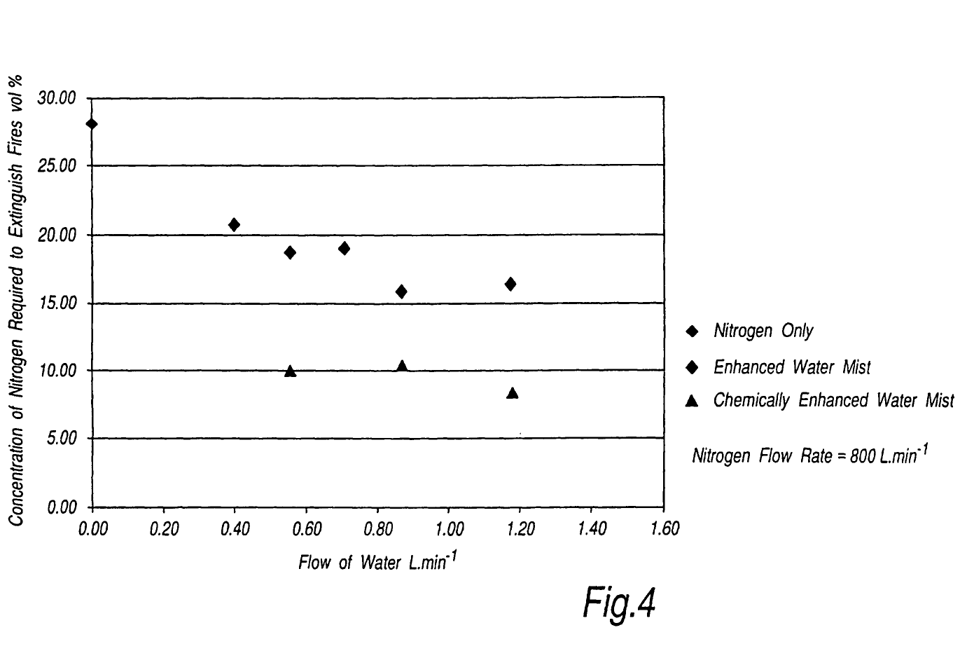

Some of the test results showing minimum extinguishing concentrations are illustrated in FIG. 4.

The systems described can also provide fire extinguishing and suppression capabilities existing over much longer periods of time. For example, a system purely using inert gas on its own is required to discharge in less than 60 seconds. A water mist system, on the other hand, can operate for several minutes or even hours depending on the system.

Water mist fire extinguishing systems are of course known in which an inert gas under pressure and water under pressure are arranged to impinge mutually to cause a shearing action on the water and thus the production of a water mist, this water mist then being propelled towards a fire to be extinguished by the pressurised inert gas. In such systems, however, the fire extinguishing medium consists substantially only of the water mist, except near the end of the discharge when most of the water has been deployed, when a stream of the inert gas may then have some fire suppression effect. In such systems, the water mist is discharged in jet-like form towards the fire, and cannot therefore provide a total flooding capability.

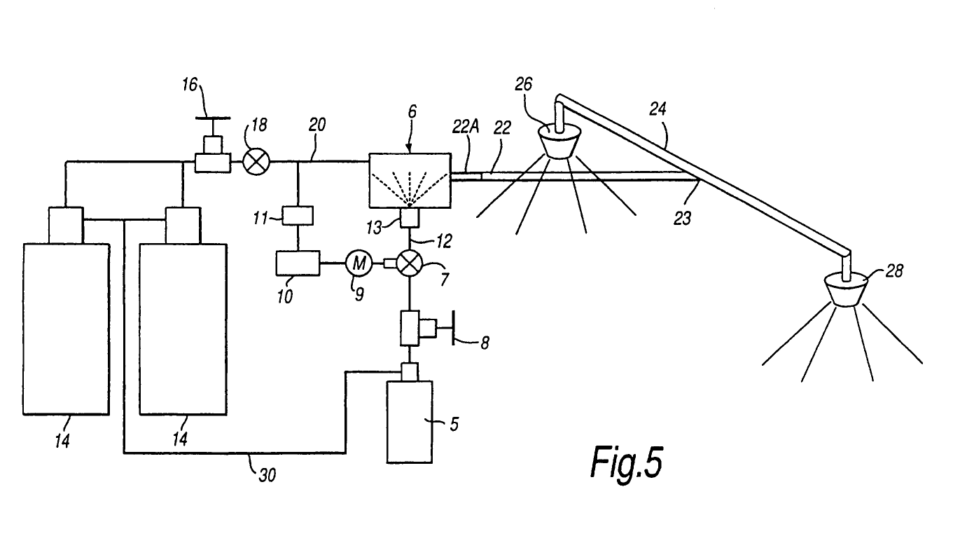

In the system shown in FIG. 5, parts corresponding to those in FIG. 1 are similarly referenced.

As shown in FIG. 5, the water in the vessel 5 is pressurised by the gas pressure in the vessels 14 via the interconnection 30. The pipe 12 between the vessel 5 and the nozzle 13 includes a metering valve 7 for a purpose to be described and a flow regulator 8. The valve 7 is adjustable by a stepper motor 9 under control of a control unit 10. The control unit 10 receives an input from a mass flow measurement device 11 in the pipe 20 between the gas vessels 14 and the mixing chamber 6.

In use, and in response to detection of a fire or explosion as explained in conjunction with FIG. 1, the flow regulators 8 and 18 are opened. Water from the vessel 5 and gas from the vessels 14 are fed under high pressure along the pipe 12 and 20. The misting nozzle 13 produces a mist of water droplets which is injected into the mixing chamber 6 where it is effectively added to the inert gas received via the pipe 20. The resultant two-phase mixture exits from the spreaders 26,28 into the volume to be protected as already explained.

Tests have shown that the ratio between the mass flow rate of the water (M_{w}) to the misting nozzle 13 and the mass flow rate of the gas (M_{g}) along the pipe 20 to the mixing chamber 6 is a significant factor for determining the resultant droplet size distribution (DSD) in the mist which is discharged through the spreaders 26,28. If M_{w} is substantially constant while M_{g} rapidly decays (as the gas is discharged from the bottles 14), it is found that the median value of DSD increases during the discharge—which is not conducive to good extinguishing performance. It has been found that suitable adjustment of the ratio M_{w}/M_{g} can produce a more satisfactory DSD, in particular a value for DSD which is approximately constant for the entirety of the discharge.

In accordance with a feature of the system shown in FIG. 5, the water in the vessel 5 is pressurised by the gas within the vessels 14, via the interconnection 30. The metering valve 7 in the pipe 12 between the vessel 5 and the nozzle 13 enables the initial flow rate of the water in the pipe 12 (that is, the value of M_{w}) to be set. During discharge, the water is forced out of the vessel 5 by the gas pressure in the vessels 14 and passes through the metering valve 7 into the nozzle 13 where it is converted into a mist within the mixing chamber 6. At the same time, the gas is forced along the pipe 20 into the mixing chamber 6. As the gas pressure in the vessels 14 decays, there will clearly be a reduction in the value of M_{w}. At the same time, though, the reduced gas pressure will cause a reduction in the value of M_{g} in the pipe 20. Approximately, therefore, the ratio of M_{w} to M_{g} remains constant throughout the discharge. It is found that DSD remains substantially constant for the entirety of the discharge, and this in turn is found to produce improved fire extinguishing capabilities.

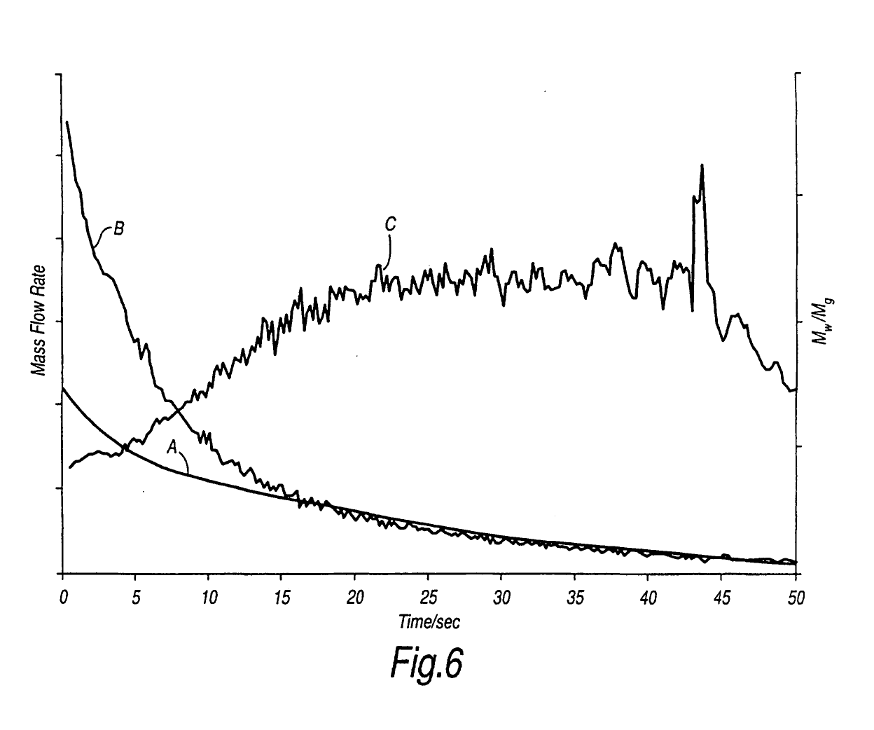

FIG. 6 shows the results of a more detailed investigation into the values of M_{w} and M_{g} during discharge. Curve A shows the value of M_{w}, curve B shows the value of M_{g} and curve C shows the value of the ratio of M_{w}/M_{g}. Curve C shows that the ratio M_{w}/M_{g} is substantially constant for the majority of the discharge and close to unity. However, there is a significant deviation from constancy during the early stages of the discharge. This suggests that an increase in the value of M_{w} during the early part of the discharge should be beneficial, because it will raise the value of the ratio M_{w}/M_{g} towards unity during this part of the discharge. This is found to increase the number of fine water droplets in the discharge and to improve the extinguishing capabilities.

In accordance with a feature of the system shown in FIG. 5, therefore, the flow metering valve 7 is arranged to be dynamically adjustable during the discharge. The metering valve 7 can be implemented as a motorised valve driven by the stepper motor 9 under control of the control unit 10. The control unit 10 is responsive to an input dependent on the decaying mass flow rate M_{g} in the pipe 20 during discharge, received from the mass flow measuring device 11 (or alternatively it could receive an input dependent on decaying pressure in the vessels 14). In a modification not shown, the control unit 10 is pre-programmed with values determined either via a flow prediction model or empirically. The control unit 10 thus energises the stepper motor 9 to achieve a desired value of the ratio M_{w}/M_{g} throughout the discharge in order to give a desired value for the DSD.

If a system of the type shown in FIG. 5 is used to protect multiple areas (e.g. multiple rooms), there may be a single water cylinder fed by several gas cylinders. In the event of a fire, the number of gas cylinders activated (that is, opened) will depend on the number of areas or rooms where discharge is required. Thus, the metering valve 7 could be adjusted by the control unit 10 in dependence on the number of activated gas cylinders (and to tend to keep the ratio M_{w}/M_{g} constant).

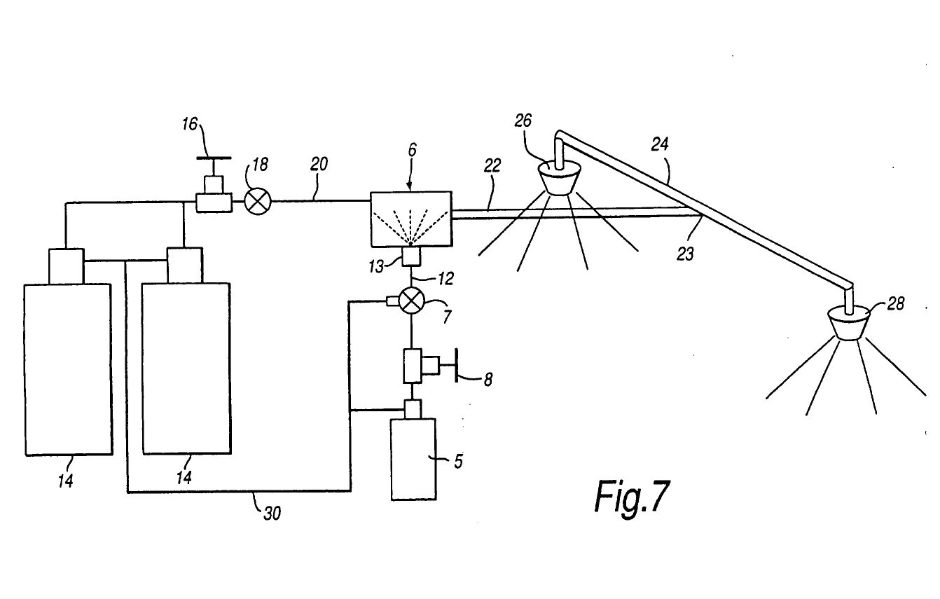

FIG. 7 shows a modification of the system of FIG. 5 in which the metering valve 7 is directly controlled by the pressure in the vessels 14 (via a branch from the interconnection 30). Such a modification avoids the need for the motor 9, the control unit 10 and the measuring device 11. The characteristics of the valve 7 would be selected so that it was adjusted by the decaying gas pressure in such a way as to tend to keep the ratio M_{w}/M_{g} constant. In such an arrangement, M_{g} will be determined by the regulator 18 which will be sonically choked. M_{w} will be proportional to the square root of the pressure forcing the water out of the vessel 5, that is, the pressure in the interconnection 30. M_{w} will be directly proportional to the effective size of the varying orifice in the metering valve 7. Thus, if the metering valve 7 is a pressure control proportioning water valve having an orifice size directly controlled by the gas pressure, this will tend to keep the ratio M_{w}/M_{g} constant.

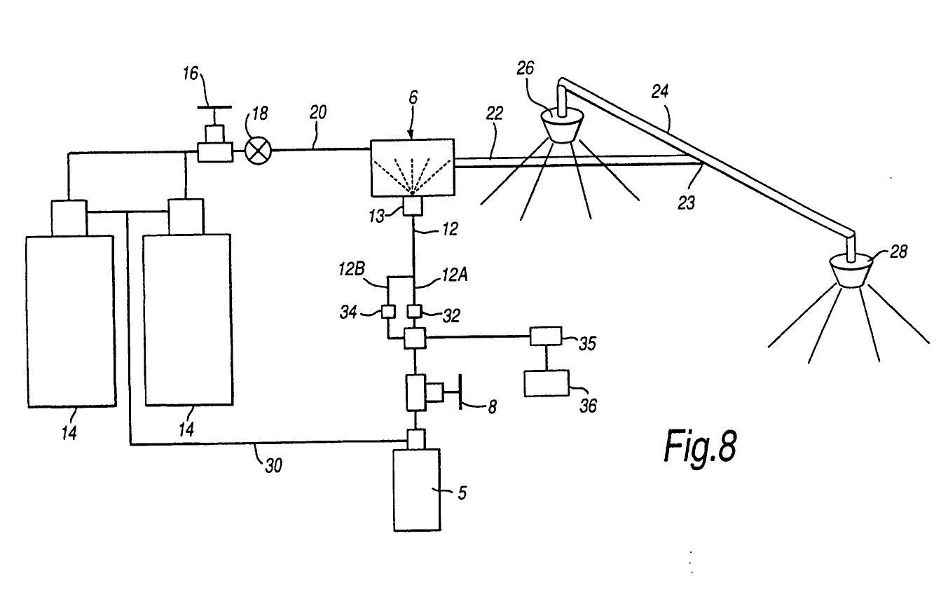

FIG. 8 shows another modified form of the system of FIG. 5, in which the relative complexity of the continuously variable metering valve 7 of FIG. 1 is avoided. As shown in FIG. 8, the water from the vessel 5 can be fed to the nozzle 13 via either of two pipes 12A and 12B under control of a selector valve 29. In a modification not shown valve 29 comprises two separate selector valves. Pipe 12A incorporates a control orifice 32 having a relatively large open cross-section while pipe 12B incorporates a control orifice 34 having a relatively small open cross-section. In this way, therefore, the selector valve 29 can vary the value for M_{w} by selecting either the pipe 12A or the pipe 12B to feed the pressurised water to the nozzle 13.

For example, during the early part of discharge, the selector valve 29 will select pipe 12A so that the value for M_{w} is relatively high. After an initial period, when the pressure in the gas vessels 14 has decreased sufficiently, the selector valve 29 selects pipe 12B instead of 12A.

The selector valve 29 can be operated by an actuator 35 under control of a control unit 36. The control unit 36 can simply measure the elapsed time since the beginning of discharge, and switch off pipe 12A and switch on pipe 12B instead after a fixed time has elapsed. In a modification (not shown), the control unit could measure the value of M_{g} in the pipe 20, or the pressure in the gas vessels 14, and switch from pipe 12A to pipe 12B when the measured value has decreased sufficiently.

If two separate selector valves are used, then during the early part of discharge the selector valves will select pipes 12A and 12B so that the combined M_{w} is relatively high. After an initial period, when the pressure in the gas vessels 14 has decreased sufficiently, the selector valves are set to select pipe 12B only.

Although only two control orifices are shown in FIG. 7, allowing selection between a relatively large open cross-section and a relatively open cross-section, it will be understood that more than two such orifices could be provided, to give a greater number of changes in values of M_{w}.

It has been found that control of the ratio M_{w}/M_{g} is difficult at the end of the discharge, and large water droplets may occur which are considered to be undesirable. Therefore, the water flow from the vessel 5 may be stopped completely near the end of the discharge, to allow the remaining gas to remove any water residue present in the pipe network. The water flow could be switched off using the metering valve 7 of FIG. 5 or 7 or the selector valve 29 of FIG. 8 (which would have an appropriate intermediate setting). Instead, a separate cut-off valve could be used.

When discharge is initiated, the pressure of the gas within the vessels 14, and the value of M_{g}, decay very rapidly. Tests on a particular installation have shown that 25% of the total mass of the gas has been discharged within two seconds of initiation of the discharge, and 50% of the total mass of the gas has been discharged within seven seconds. Clearly, therefore, it is important to use the first few seconds of discharge as effectively as possible. In accordance with a feature of the systems being described, therefore, the flow regulator 8 can be opened before the flow regulator 18. The pressure of the gas exerted on the water in the vessel 5 via the interconnection 30 will thus ensure that some water is present at the misting nozzle 13 when the gas valve is subsequently opened. This therefore helps to ensure that discharge of water mist through the spreaders 26,28 takes place substantially instantaneously upon the opening of the flow regulator 18, to take maximum advantage of the initial gas pressure. Furthermore, the initial presence of the water at the misting nozzle 13, when the flow regulator 18 is opened, helps to reduce problems (e.g. formation of ice) caused by the extremely low temperatures when the gas discharge starts.

It is also believed to be advantageous to ensure that an excess of water is present when discharge starts, to aid wetting of the pipe network. For example, a section 22A of the outlet pipe 22 (see FIG. 5) can be sealed off at each of its ends by a burst disc and filled with water. When discharge starts, the pressure in the pipe 22 bursts the discs, making the trapped water available for pipe wetting.

Although the systems shown in FIGS. 5,7 and 8 pressurise the water in the vessel 5 using the gas pressure in the vessels 14 (via the interconnection 30), providing an advantageous tendency to maintain the ratio M_{w}/M_{g} constant, this method of pressurising the water is not essential. Instead, for example, the water in the vessel 5 could be pressurised in some other suitable way such as by means of a controllable pump. In such a case, a suitable control unit could be used to control the value of M_{w}, by varying the pump pressure, in such a way as to tend to keep the ratio M_{w}/M_{g} at such value (for example, unity) to achieve a desired DSD.

In this specification and its claims, the term “water” includes acqueous solutions or suspensions primarily comprising water but possibly also including other substances.

In a modification, however, the water can be replaced by another suitable liquid extinguishing agent which is formed into a mist of droplets (in the same way as for the water) and then added to the inert gas in the manner explained and discharged through the spreaders 26,28. The liquid extinguishing agent is selected to have a short atmospheric lifetime of less than 30 days to minimise its global warming potential.

Suitable liquid chemical extinguishing agents, having such short atmospheric lifetimes, can comprise one or more chemicals with the structure Z—R—X—Y, where the monovalent radical Z is a halogen atom taken from the group fluorine (—F), or bromine (—Br); where the divalent radical R is a perfluoro- or polyfluoro-alkylidene group of formula —CₙHₚF₂ₙ₋ₚ with n in the range 1-6 and p in the range 0-4; where the divalent radical X is selected from the group ether (—O—), trifluoromethylimino (—N(CF3)—), carbonyl (—CO—), or ethenyl (—CW═CH—) with W being either H or Br; where the monovalent radical Y is selected from the group hydrogen (—H), bromine (—Br), alkyl of formula —CₘH₂ₘ₊₁ with m in the range 1-4, or perfluoroalkyl of formula —CₘF₂ₘ₊₁ with m in the range 1-4, or polyfluoroalkyl of formula —CₘHₖF₂ₘ₊₁₋ₖ with m in the range 1-4 and k in the range 1-2m; and where, optionally, the radicals R and Y may be linked (by a C-C bond) such as to form a 4-, 5-, or 6-membered ring.

Preferably, the groups Z,X and Y are so selected that the total number of bromine atoms in the molecule does not exceed one.

Preferably, the groups R and Y are selected such that n-m lies in the range 1-6 with the further proviso that n-m must be at least 1.

Preferably, the groups R,X, and Y are chosen so that the total number of carbon atoms in the molecule is in the range 3-8, and very preferably in the range 3-6.

Preferably, the molecular weight of the molecule lies in the range 150-400, and very preferably in the range 150-350.

Preferably, the groups R,X and Y are chosen so the weight % of halogen (fluorine and bromine) in the molecule lies in the range 70-90%, and very preferably in the range 70-80%.

More specific examples of suitable suppressants are as shown in the Table on the following two pages. At the end of the Table, a list of three atmospheric degradation mechanisms is given, numbered 1 to 3. Using these numbers, the penultimate column of the Table indicates the particular degradation mechanism relevant to each agent.

| | | | | | n-Heptane | Mechanism | |
|---|---|---|---|---|---|---|---|
| | | | | Boiling Point | Cupbumer | of | Estimated |
| | | | | at | Extinguishing | Degradation | Atmospheric |
| | | | Halogen | 1 atmosphere | Concentration | (see note at | Lifetime |
| Extinguishing Agent | Formula | Mwt | (%) | (° C.) | (volume %) | end of Table) | (days) |
| 2-bromo-1,1,2-trifluoro-1-methoxyethane | CH₃OCF₂CHFBr | 193 | 71 | 89 | 4.2 ± 0.6 | 1 | 14 |
| | | | | | (estimated) | | |
| 2-bromo-1,1,2,2-tetrafluoro-1- | CH₃OCF₂CF₂Br | 211 | 74 | 80-90 | ˜4.0-4.5 | 1 | 14 |
| methoxyethane | | | | | | | |
| 2-bromo-1′,1′,1′,2,2-pentafluoro-1- | CF₃OCH₂CF₂Br | 229 | 76 | | ˜4 | 1 | <20 |
| methoxyethane | | | | | | | |
| 2-bromo-2,3,3-trifluoro-1- | [—CH₂CF₂CFBrCH₂—]O | 205 | 67 | | 4.5 | 1 | <20 |
| oxacyclopentane | | | | | | | |
| 2-(N,N-bis(trifluoromethyl)amino)-1,1- | (CF₃)₂NCH₂CF₂Br | 296 | 78 | 80 | ˜4 | 1 | <20 |
| difluoro-1-bromoethane | | | | | | | |
| 2-(N,N-bis(trifluoromethyl)amino)-1,1,2- | (CF₃)₂NCHFCF₂Br | 314 | 80 | 62 | ˜4 | 1 | <20 |
| trifluoro-1-bromoethane | | | | | | | |
| 2-(N,N-bis(trifluoromethyl)amino)-1,2- | (CF₃)₂NCHFCHFBr | 296 | 78 | 76 | ˜4 | 1 | <20 |
| difluoro-1-bromoethane | | | | | | | |
| 2-(N,N-bis(trifluoromethyl)amlno)-1- | (CF₃)₂NCH₂CH₂Br | 260 | 75 | 90 | ˜5 | 1 | <20 |
| bromoethane | | | | | | | |

| | | | | | n-Heptane | Mechanism | |
|---|---|---|---|---|---|---|---|
| | | | | Boilling Point | Cupbumer | of | Estimated |
| | | | | at | Extinguishing | Degradation | Atmospheric |
| | | | Halogen | 1 atmosphere | Concentration | (see note at | Lifetime |
| Extinguishing Agent | Formula | Mwt | (%) | (° C.) | (volume %) | end of Table) | (days) |
| 2-bromo-3,3,3-trifluoro-1-propene | CH₂═CBrCF₃ | 175 | 78 | 34 | 4.7 ± 0.2 | 2 | 3 |
| 4-bromo-3,3,4,4-tetrafluoro-1-butene | CH₂═CHCF₂CF₂Br | 207 | 75 | 65 | 5.0 ± 0.3 | 2 | 7 |
| 2-bromo-3,3,4,4,4-pentafluoro-1-butene | CH₂═CBrCF₂CF₃ | 225 | 78 | 59 | 3.8 | 2 | 3 |
| 1-bromo-3,3,4,4,4-pentafluoro-1-butene | CHBr═CHCF₂CF₃ | 225 | 78 | 58 | 3.1 | 2 | <10 |
| 1-bromo-3,3,3-trifluoro-1-propene | CHBr═CHCF₃ | 175 | 78 | 40 | 3.5 | 2 | <10 |
| 2-bromo-3,3,4,4,5,5,5-heptafluoro-1- | CH₂═CBrCF₂CF₂CF₃ | 275 | 77 | 78 | 3.7 | 2 | <10 |
| pentene | | | | | | | |
| 2-bromo-3,4,4,4,4′,4′,4′-heptafluoro-3- | CH₂═CBrCF(CF₃)₂ | 275 | 77 | 79 | 3.3 | 2 | <10 |
| methyl-1-butene | | | | | | | |
| Dodecafluoro-2-methylpentan-3-one | CF₃CF₂C(O)CF(CF₃)₂ | 316 | 72 | 48 | 4.5 ± 0.1 | 3 | 5 |

Key to atmospheric degradation mechanism
1 tropodegradable due to reaction of —OH with —OCH₃, —OCH₂—, or —NCH₂— or —NCHF— groups
2 tropodegradable due to reaction of —C═C—group with —OH
3 tropodegradable due to photolysis of CO group

1. A fire and explosion suppression system, comprising a source of liquid extinguishing agent (5) and a source (14) of pressurised inert gas, mist producing means (13;13A) connected to receive a flow of the liquid extinguishing agent to produce a mist therefrom, mixing means (6) for mixing the already-produced mist into a flow of the pressurised inert gas from the source (14) thereof to produce a discharge in the form of a two-phase mixture comprising a suspension of droplets of the mist in the pressurised inert gas, and transporting means (22) for transporting the two-phase mixture to separate discharge means.

2. A system according to claim 1, comprising control means (30,7;30,12A,12B) for controlling the ratio of the mass flow rate of the liquid extinguishing agent to the mass flow rate of the pressurised gas towards such a value as to tend to produce a desired droplet size distribution in and for substantially the duration of the discharge.

3. A system according to claim 2, in which the control means (7;12A,12B) controls the value of the ratio towards a constancy.

4. A system according to claim 2 or 3, in which the control means includes means (30) for pressurising the liquid extinguishing agent in dependence on the pressure of the inert gas.

5. A system according to claim 4, in which the pressurised inert gas is pressurised by being stored under pressure which thus reduces during the flow thereof and reduces the mass flow rate of the inert gas, and in which the control means includes means (30) for applying the pressure of the stored inert gas to pressurise the liquid extinguishing agent whereby the reducing applied pressure correspondingly reduces the mass flow rate of the liquid extinguishing agent.

6. A system according to any one of claims 2 to 5, in which the control means includes controllable valve means (7;12a,12) for controlling the mass flow rate of the liquid extinguishing agent during the discharge.

7. A system according to claim 6, in which the valve means comprises a controllable metering valve means (7) and the control means includes means (9,10) for adjusting the metering valve means in dependence on the mass flow rate of the gas.

8. A system according to claim 7, in which the valve means comprises a controllable metering valve means (7) and the control means includes means for adjusting the metering valve-means in dependence on the pressure of the stored inert gas.

9. A system according to claim 6, in which the controllable valve means comprises a plurality of parallel flow paths (12A, 12B) for feeding the liquid extinguishing agent to the mist producing means and having respective flow orifices of different cross-sectional area, in combination with selection means (29) for selecting any one or more of the flow paths.

10. A system according to any one of claims 2 to 4, in which the control means includes means for controlling the pressure of the pressurised liquid extinguishing agent.

11. A system according to claim 10, in which the control means includes a pump for pressurising the source of the liquid extinguishing agent.

12. A system according to claim 11, in which the control means includes means responsive to the mass flow rate of the inert gas for adjusting the pump to vary the pressure of the source of the liquid extinguishing agent.

13. A system according to any one of claims 2 to 12, including means for initiating the flow of the liquid extinguishing agent before initiating the flow of the inert gas.

14. A system according to any preceding claim, in which the discharge means comprises at least one outlet (26,28) and in which the transporting means comprises narrow pipe means (22) interconnecting the entraining means with the outlet.

15. A system according to claim 14, in which the Reynold's number effective in the pipe means (22) is at least 4000.

16. A system according to claim 15, in which the said Reynold's number is at least 12000.

17. A system according to any preceding claim, in which the mist producing means (13) and the source of the inert gas (14) are connected to the mixing means (6) by pipe means (20) and the mixing means (6) is at least one metre downstream of any flow restrictor in this pipe means (20).

18. A system according to any preceding claim, in which the mist producing means comprises a nozzle (13).

19. A system according to any one of claims 1 to 17, in which the mist producing means comprises an eductor (13A).

20. A fire and explosion suppression method, comprising the steps of producing a mist from a pressurised liquid extinguishing agent, mixing the already-produced mist into a flow of pressurised inert gas to produce a two-phase mixture comprising a suspension of droplets of the mist in the pressurised inert gas, and transporting the two-phase mixture for separate discharge.

21. A fire and explosion suppression method according to claim 20, including the step of controlling the ratio of the mass flow rate of the liquid extinguishing agent to the mass flow rate of the pressurised gas towards such a value as to tend to produce a desired droplet size distribution in and for substantially the duration of the discharge.

22. A method according to claim 21, in which the value of the ratio is controlled towards a constant value.

23. A method according to claim 21 or 22, in which the controlling step includes the step of pressurising the liquid extinguishing agent in dependence on the pressure of the inert gas.

24. A method according to claim 23, in which the pressurised inert gas is pressurised by being stored under pressure which thus reduces during the flow thereof and reduces the mass flow rate of the inert gas, and in which the controlling step includes the step of applying the pressure of the stored inert gas to pressurise the liquid extinguishing agent whereby the reducing applied pressure correspondingly reduces the mass flow rate of the liquid extinguishing agent.

25. A method according to any one of claims 21 to 24, in which the controlling step includes the step of controlling the mass flow rate of the liquid extinguishing agent during the discharge.

26. A method according to claim 25, in which the mass flow rate of the liquid extinguishing agent is adjusted in dependence on the mass flow rate of the gas.

27. A system according to claim 26, in which the mass flow rate of the liquid extinguishing agent is adjusted in dependence on the pressure of the stored inert gas.

28. A method according to any one of claims 21 to 23 in which the controlling step includes the step of controlling the pressure of the pressurised liquid extinguishing agent.

29. A method according to claim 28, in which the controlling step includes the step of varying the pressure of the liquid extinguishing agent in response to the mass flow rate of the inert gas.

30. A method according to any one of claims 21 to 29, including the step of initiating the flow of the liquid extinguishing agent before initiating the flow of the inert gas.

31. A method according to any one of claims 20 to 30, in which the mist is entrained and transported while being longitudinally and cross-sectionally confined.

32. A method according to claim 31, in which the mist is entrained and transported in conditions in which the effective Reynold's number is at least 4000.

33. A method according to claim 32, in which the Reynold's number is at least 12000.

34. A system according to any one of claims 1 to 19 or a method according to any one of claims 20 to 33, in which the liquid extinguishing agent is water.

35. A system or method according to claim 34, in which the median droplet size of the water mist lies between 5 and 60 micrometres.

36. A system or method according to claim 34 or 35, in which the water is mixed with a chemical fire suppressant carried by the mist.

37. A system or method according to claim 36, in which the chemical fire suppressant is potassium hydrogen carbonate.

38. A system according to any one of claims 1 to 19 or a method according to any one of claims 20 to 33, in which the liquid extinguishing agent is a chemical substance comprising one or more chemicals with the structure Z—R—X—Y, where the monovalent radical Z is a halogen atom taken from the group fluorine (—F) or bromine (—Br); where the divalent radical R is a perfluoro- or polyfluoro-alkylidene group of formula —CₙHₚF₂ₙ₋ₚ with n in the range 1-6 and p in the range 0-4; where the divalent radical X is selected from the group ether (—O—) trifluoromethylimino (—N(CF₃)-), carbonyl (—CO—), or ethenyl (—CW═CH—) with W being either H or Br; and where the monovalent radical Y is selected from the group hydrogen (—H—), bromine (—Br—), alkyl of formula —CₘH₂ₘ₊₁ with m in the range 1-4, or perfluoroalkyl of formula —CₘF₂ₘ₊₁ with m in the range 1-4, or polyfluoroalkyl of formula —CₘHₖF₂ₘ₊₁₋ₖ with m in the range 1-4 and k in the range 1-2m; the agent including nothing else having any significant environmental impact and which has an atmospheric lifetime longer than 30 days.

39. A system or method according to claim 38, in which the radicals R and Y are linked (by a C—C bond) such as to form a 4-, 5- or 6-membered ring.

40. A system or method according to claim 38 or 39, in which the groups Z, X and Y are so selected that the total number of bromine atoms in the molecule does not exceed one.

41. A system or method according to any one of claims 38 to 40, in which the groups R and Y are selected such that n+m lies in the range 1-6, and n-m is at least 1.

42. A system or method according to any one of claims 38 to 41, in which the groups R, X and Y are chosen so that the total number of carbon atoms in the molecule is in the range 3-8.

43. A system or method according to claim 42, in which the total number of the said carbon atoms is in the range 3-6.

44. A system or method according to any one of claims 38 to 43, in which the molecular weight of the molecule lies in the range 150-400.

45. A system or method according to claim 44, in which the said molecular weight lies in the range 150-350.

46. A system or method according to any one of claims 38 to 41, in which the groups R, X and Y are chosen so that the weight% of halogen (fluorine and bromine) in the molecule lies in the range 70-90%.

47. A system or method according to claim 38, in which the chemical substance comprises 2-bromo-1,1,2-trifluoro-1-methoxyethane.

48. A system or method according to claim 38, in which the chemical substance is 2-bromo-1,1,2,2-tetrafluoro-1-methoxyethane.

49. A system or method according to claim 38, in which the chemical substance is 2-bromo-1′, 1′, 1′,2,2-pentafluoro-1-methoxyethane.

50. A system or method according to claim 38, in which the chemical substance is 2-bromo-2,3,3-trifluoro-1-oxacyclopentane.

51. A system or method according to claim 38, in which the chemical substance is 2-(N,N-bis(trifluoromethyl)amino)-1,1-difluoro-1-bromoethane.

52. A system or method according to claim 38, in which the chemical substance is 2-(N,N-bis(trifluoromethyl)amino)-1,1,2-trifluoro-1-bromoethane.

53. A system or method according to claim 38, in which the chemical substance is 2-(N,N-bis(trifluoromethyl)amino)-1,2-difluoro-1-bromoethane.

54. A system or method according to claim 38, in which the chemical substance is 2-(N,N-bis(trifluoromethyl)amino)-1-bromoethane.

55. A system or method according to claim 38, in which the chemical substance is 2-bromo-3,3,3-trifluoro-1-propene.

56. A system or method according to claim 38, in which the chemical substance is 4-bromo-3,3,4,4-tetrafluoro-1-butene.

57. A system or method according to claim 38, in which the chemical substance is 2-bromo-3,3,4,4,4-pentafluoro-1-butene.

58. A system or method according to claim 38, in which the chemical substance is 1-bromo-3,3,4,4,4-pentafluoro-1-butene.

59. A system or method according to claim 38, in which the chemical substance is 1-bromo-3,3,3,-trifluoro-1-propene.

60. A system or method according to claim 38, in which the chemical substance is 2-bromo-3,3,4,4,5,5,5-heptafluoro-1-petene.

61. A system or method according to claim 38, in which the chemical substance is 2-bromo-3,4,4,4,4′,4′,4′-heptafluoro-3-methyl-1-butene.

62. A system or method according to claim 38, in which the chemical substance is dodecafluoro-2-methylpentan-3-one.

63. A system or method according to any preceding claim, in which the pressurised gas is nitrogen.

64. A system or method according to any one of claims 1 to 62, in which the pressurised gas is argon.

65. A system or method according to any one of claims 1 to 62, in which the pressurised gas is a nitrogen and argon mixture.

66. Apparatus for producing a mist from a liquid, comprising an eductor (13A).

67. Apparatus according to claim 66, including means (5) connected to supply the liquid to the eductor (13A) and means (14) connected to supply a gas to the eductor (13A), the gas causing a reduction of ambient pressure in the eductor (13A) which draws the liquid into the eductor (13A).

68. Apparatus according to claim 66 or 67, in which the liquid is water.

69. Apparatus according to claims 66 or 67, in which the liquid is a chemical substance.

70. A method of producing a mist from a liquid, in which a gas is fed under pressure to an eductor (13A) to draw the liquid into the eductor (13A) to produce the mist.

71. A method according to claim 70, in which the liquid is water.

72. A method according to claim 71, in which the liquid is a chemical substance.
